(19) United States
(12) Patent Application Publication
(10) Pub. No.: US 2018/0102723 A1
(43) Pub. Date: Apr. 12, 2018

(54) IN-VEHICLE INVERTER DRIVING DEVICE AND IN-VEHICLE FLUID MACHINE

(71) Applicant: KABUSHIKI KAISHA TOYOTA JIDOSHOKKI, Kariya-shi (JP)

(72) Inventors: Takashi KAWASHIMA, Kariya-shi (JP); Tomohiro TAKAMI, Kariya-shi (JP); Kazuki NAJIMA, Kariya-shi (JP); Yoshiki NAGATA, Kariya-shi (JP)

(73) Assignee: KABUSHIKI KAISHA TOYOTA JIDOSHOKKI, Kariya-shi, Aichi-ken (JP)

(21) Appl. No.: 15/724,530

(22) Filed: Oct. 4, 2017

(30) Foreign Application Priority Data
Oct. 11, 2016 (JP) 2016-200114

(51) Int. Cl. H02P 27/08; H02P 21/22; B60L 11/18; H02M 7/5395; H02M 1/08

(52) U.S. Cl. CPC H02P 27/08; H02P 21/22; B60L 11/1803; H02M 7/5395; H02M 2001/0054; B60L 2210/40; B60L 2220/14; B60L 2220/16; H02M 1/08

(57) ABSTRACT

An in-vehicle inverter driving device is used to perform PWM control of an inverter circuit that drives an electric motor. The electric motor includes a rotor having a permanent magnet and a stator about which three-phase coils are wound. The in-vehicle inverter driving device includes a bootstrap circuit, which uses a capacitor to turn ON upper arm switching elements of the inverter circuit. The in-vehicle inverter driving circuit includes a PWM control section that controls the inverter circuit by a lower-arm-fixing two-phase modulation method. The PWM control section performs shift correction and dead-time correction in the lower-arm-fixing two-phase modulation method.

### BACKGROUND OF THE INVENTION

The present invention relates to an in-vehicle inverter driving device and an in-vehicle fluid machine.

For example, the in-vehicle inverter driving device disclosed in Japanese Laid-Open Patent Publication No. 2015-208187 is used for PWM control of an inverter circuit that drives an electric motor having a rotor including permanent magnets and a stator around which three-phase coils are wound. Japanese Laid-Open Patent Publication No. 2007-110780 discloses modulation methods for an inverter circuit that drives an electric motor mounted in an electric vehicle that include a three-phase modulation method and a two-phase modulation method and that the modulation method is changed, for example, in accordance with the rotational speed the electric motor.

The two-phase modulation method is preferable when focusing on switching loss because this method is more likely to reduce the number of times of switching than the three-phase modulation method. Two-phase modulation methods include an upper/lower two-phase modulation method, which maintains either the upper arm switching element or the lower arm switching element of a fixed phase in the ON state.

Some in-vehicle inverter driving devices include a bootstrap circuit that has a capacitor and employ a bootstrap method, in which an upper arm switching element is turned ON by using the capacitor. In this case, the period during which the upper arm switching element can be maintained in the ON state is limited by the capacitance of the capacitor. Thus, in some cases, the upper arm switching element cannot be maintained in the ON state over a long period of time.

In this regard, the inventors of the present invention focused attention on the lower-arm-fixing two-phase modulation method, which is a two-phase modulation method that does not require maintaining the upper arm switching element in the ON state for a long period of time. The lower-arm-fixing two-phase modulation method is a two-phase modulation method in which the upper arm switching element of the fixed phase is maintained in the OFF state and the lower arm switching element of the fixed phase is maintained in the ON state.

In the PWM control, a dead time is provided at the time of switching such that the upper arm switching element and the lower arm switching element that are subjected to the switching operation are not simultaneously turned ON. Thus, the pulse width of each of the switching elements subjected to the switching operation can deviate from the target value to the extend corresponding to the dead time.

To cope with this, dead-time correction may be performed to adjust the pulse widths of the switching elements subjected to the switching operation in correspondence with the dead time. The inventors of the present invention have found out that, in this configuration, the controllability of the electric motor tends to deteriorate when the dead-time correction is performed in the lower-arm-fixing two-phase modulation method.

### SUMMARY OF THE INVENTION

Accordingly, it is an objective of the present invention to provide an in-vehicle inverter driving device and an in-vehicle fluid machine capable of restraining reduction in the controllability of an electric motor while suppressing the switching loss.

To achieve the foregoing objective and in accordance with a first aspect of the present invention, an in-vehicle inverter driving device is provided that is used to perform PWM control of an inverter circuit that drives an electric motor. The electric motor includes a rotor having a permanent magnet and a stator about which three-phase coils are wound. The inverter circuit includes three-phase upper arm switching elements, which are connected to a high-voltage side of a DC power supply, and three-phase lower arm switching elements, which are connected to a low-voltage side of the DC power supply. The in-vehicle inverter driving device includes a bootstrap circuit and a lower-arm-fixing two-phase modulation command value deriving section. The bootstrap circuit includes a capacitor and uses the capacitor to turn ON the three-phase upper arm switching elements. The lower-arm-fixing two-phase modulation command value deriving section derives lower-arm-fixing two-phase modulation command values of three phases. The lower-arm-fixing two-phase modulation command values are voltage command values corresponding to a lower-arm-fixing two-phase modulation method. In the lower-arm-fixing two-phase modulation method: one of the three phases sequentially becomes a fixed phase; in a state in which a dead time is set, a switching operation is performed on the upper and lower arm switching elements of the two phases other than the fixed phase; the upper arm switching element of the fixed phase is maintained in an OFF state; and the lower arm switching element of the fixed phase is maintained in an ON state. The in-vehicle inverter driving device further includes a specific modulation control section, which performs a dead-time correction to adjust pulse widths of the lower-arm-fixing two-phase modulation command values of the three phases in accordance with the dead time and corrects the lower-arm-fixing two-phase modulation command values of the three phases such that a three-phase modulation method is executed during a fixed period.

To achieve the foregoing objective and in accordance with a second aspect of the present invention, an in-vehicle inverter driving device is provided that is used to perform PWM control of an inverter circuit that drives an electric motor. The electric motor includes a rotor having a permanent magnet and a stator about which three-phase coils are wound. The inverter circuit includes three-phase upper arm switching elements, which are connected to a high-voltage side of a DC power supply, and three-phase lower arm switching elements, which are connected to a low-voltage side of the DC power supply. The in-vehicle inverter driving device includes a bootstrap circuit and a command value deriving section. The bootstrap circuit includes a capacitor and uses the capacitor to turn ON the three-phase upper arm switching elements. The command value deriving section drives lower-arm-fixing two-phase modulation command values of three phases. The lower-arm-fixing two-phase modulation command values are three-phase voltage command values corresponding to a lower-arm-fixing two-phase modulation method. In the lower-arm-fixing two-phase modulation method: one of the three phases sequentially becomes a fixed phase; in a state in which a dead time is set, a switching operation is performed on the upper and lower arm switching elements of the two phases other than the fixed phase; the upper arm switching element of the fixed phase is maintained in an OFF state; and the lower arm switching element of the fixed phase is maintained in an ON state. The in-vehicle inverter driving device further includes a shifting correction section and a specific modulation control section. The shifting correction section performs a shifting correction to subtract a predetermined shifting correction amount from each of the lower-arm-fixing two-phase modulation command values of the three phases over a shifting correction period, thereby deriving three-phase first correction command values that are set such that, in the shifting correction period, the modulation method is the three-phase modulation method and a neutral point voltage is shifted. The specific modulation control section includes a dead-time correction section. The dead-time correction section performs a dead-time correction for the three-phase first correction command values, thereby deriving three-phase second correction command values. The specific modulation control section controls the inverter circuit based on the second correction command values. The dead-time correction is a correction in which pulse widths of the two switching elements subjected to the switching operation are adjusted in accordance with the dead time. The shifting correction period is set in accordance with the error period such that, when the dead-time correction is performed for the three-phase first correction command values, an error period, in which two of the three phases become fixed phases, is shortened or not generated.

To achieve the foregoing objective and in accordance with a third aspect of the present invention, an in-vehicle fluid machine is provided that includes an electric motor, which includes a rotor having a permanent magnet and a stator about which three-phase coils are wound, an inverter circuit, which drives the electric motor, and the above described in-vehicle inverter driving device.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram schematically showing an in-vehicle inverter driving device and an in-vehicle motor-driven compressor;

FIG. 2 is a block diagram schematically showing an in-vehicle driving device and the in-vehicle inverter driving device;

FIG. 3 is a graph of upper/lower two-phase modulation command values;

FIG. 4 is a graph of a lower-arm-fixing two-phase modulation command value in an ideal condition;

FIG. 5 is a flowchart showing a PWM control process;

FIG. 6A is a timing diagram showing a manner in which the u-phase upper arm switching element is switched for which dead time is set under a condition in which the dead-time correction is not being performed;

FIG. 6B is a timing diagram showing a manner in which the u-phase lower arm switching element is switched for which dead time is set under a condition in which the dead-time correction is not being performed;

FIG. 6C is a timing diagram showing a manner in which the u-phase upper arm switching element is switched for which the dead-time correction has been performed;

FIG. 6D is a timing diagram showing a manner in which the u-phase lower arm switching element is switched for which the dead-time correction has been performed;

FIG. 7 is a graph of a fictitious correction command value;

FIG. 8 is a graph of a first correction command value; and

FIG. 9 is a graph of a second correction command value.

### DETAILED DESCRIPTION OF THE PREFERRED EMBODIMENTS

An in-vehicle inverter driving device, an in-vehicle fluid machine equipped with the in-vehicle inverter driving device, and a vehicle according to one embodiment will be described. In the present embodiment, the in-vehicle fluid machine is an in-vehicle motor-driven compressor that is used in an in-vehicle air conditioner.

An overview of the in-vehicle air conditioner and the in-vehicle motor-driven compressor will now be described.

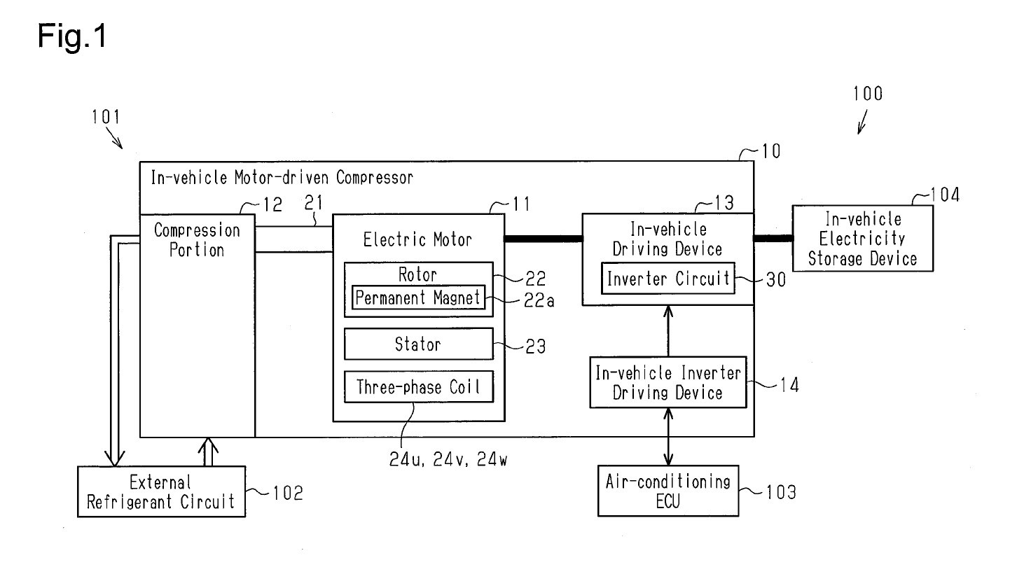

As shown in FIG. 1, a vehicle 100 has an in-vehicle air conditioner 101, which includes an in-vehicle motor-driven compressor 10 and an external refrigerant circuit 102. The external refrigerant circuit 102 supplies refrigerant, which is a fluid, to the in-vehicle motor-driven compressor 10. The external refrigerant circuit 102 includes, for example, a heat exchanger and an expansion valve. The in-vehicle motor-driven compressor 10 compresses the refrigerant, and the external refrigerant circuit 102 performs heat exchange of the refrigerant and expands the refrigerant. This allows the in-vehicle air conditioner 101 to cool or warm the passenger compartment.

The in-vehicle air conditioner 101 includes an air-conditioning ECU 103, which controls the entire in-vehicle air conditioner 101. The air-conditioning ECU 103 is configured to obtain parameters such as the temperature of the passenger compartment and a target temperature. Based on the parameters, the air-conditioning ECU 103 outputs various commands such as an ON-OFF command to the in-vehicle motor-driven compressor 10. The vehicle 100 includes an in-vehicle electricity storage device 104. The in-vehicle electricity storage device 104 may be any type as long as it can charge/discharge DC power. For example, a rechargeable battery or an electric double-layer capacitor may be employed. The in-vehicle electricity storage device 104 is used as a DC power supply for the in-vehicle motor-driven compressor 10. The in-vehicle electricity storage device 104 corresponds to a DC power supply.

Although not shown, the in-vehicle electricity storage device 104 is also electrically connected to in-vehicle devices other than the in-vehicle motor-driven compressor 10 and also supplies power to the other in-vehicle devices. Thus, noise flowing out from other in-vehicle devices can be transmitted to the in-vehicle motor-driven compressor 10. Other in-vehicle devices include, for example, a power control unit. The in-vehicle motor-driven compressor 10 includes an electric motor 11, a compression portion 12, an in-vehicle driving device 13, which has an inverter circuit 30 for driving the electric motor 11, and an in-vehicle inverter driving device (an in-vehicle inverter control device) 14 used to control the inverter circuit 30.

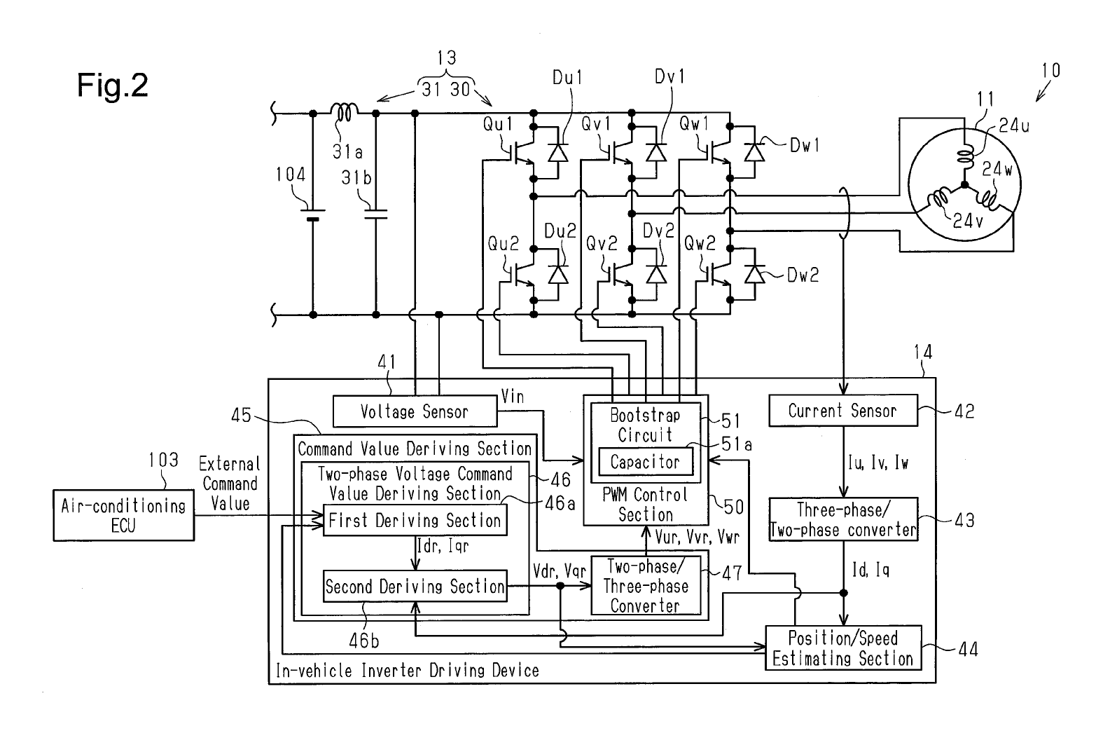

The electric motor 11 includes a rotary shaft 21, a rotor 22 fixed to the rotary shaft 21, a stator 23 arranged to be opposed to the rotor 22, and three-phase coils 24u, 24v, 24w wound about the stator 23. The rotor 22 includes permanent magnets 22a. Specifically, the permanent magnets 22a are embedded in the rotor 22. As shown in FIG. 2, the three-phase coils 24u, 24v, 24w are connected to form a Y-connection. The rotor 22 and the rotary shaft 21 rotate when the three-phase coils 24u, 24v, 24w are energized in a predetermined pattern. That is, the electric motor 11 is a three-phase motor. The manner in which the three-phase coils 24u, 24v, 24w are connected together is not limited to the Y-connection, but may be a delta connection.

When the electric motor 11 operates, the compression portion 12 compresses the refrigerant. Specifically, when the rotary shaft 21 is rotated, the compression portion 12 compresses refrigerant drawn in from the external refrigerant circuit 102 and discharges the compressed refrigerant. The compression portion 12 may be any type such as a scroll type, a piston type, and a vane type.

As shown in FIG. 2, the in-vehicle driving device 13 includes a filter circuit for reducing noise (in other words, a noise reduction circuit) 31. The filter circuit 31 is arranged on the input side of the inverter circuit 30. The filter circuit 31 is composed of, for example, an LC resonance circuit having an inductor 31a and a capacitor 31b. The filter circuit 31 reduces noise included in DC current delivered from the in-vehicle electricity storage device 104 (hereinafter, referred to as inflow noise) in a frequency band lower than the resonance frequency f0 of the filter circuit 31. The inverter circuit 30 receives DC current in which noise has been reduced by the filter circuit 31.

The inflow noise includes, for example, noise caused by switching of the switching elements mounted on in-vehicle devices that share the in-vehicle electricity storage device 104 with the in-vehicle motor-driven compressor 10. The frequency of the inflow noise varies according to the type of the vehicle. The resonance frequency f0 of the filter circuit 31 is set to be higher than the assumed frequency bands including inflow noises in assumed types of vehicles. That is, the resonance frequency f0 of the filter circuit 31 is set to be high so as to be applicable to a number of types of vehicles.

The specific configuration of the filter circuit 31 may be any type such as n type and T type that include a plurality of capacitors 31b and inductors 31a. The inductor 31a may be omitted. In this case, it is preferable to configure the filter circuit 31 (resonance circuit) by using the parasitic inductor of the capacitor 31b. The number of the filter circuit 31 is not limited to one but may be more than one.

The inverter circuit 30 converts DC power delivered from the filter circuit 31 into AC power. The inverter circuit 30 includes u-phase switching elements Qu1, Qu2 corresponding to the u-phase coil 24u, v-phase switching elements Qv1, Qv2 corresponding to the v-phase coil 24v, and w-phase switching elements Qw1, Qw2 corresponding to the w-phase coil 24w.

The switching elements Qu1, Qu2, Qv1, Qv2, Qw1, and Qw2 (hereinafter, simply referred to as the switching elements Qu1 to Qw2) are each a power switching element constituted, for example, by an insulated gate bipolar transistor (IGBT). The switching elements Qu1 to Qw2 are not limited to IGBTs, but may be any type of switching elements. The switching elements Qu1 to Qw2 include freewheeling diodes (body diodes) Du1 to Dw2.

The u-phase switching elements Qu1, Qu2 are connected to each other in series by a connection wire that is connected to the u-phase coil 24u. The collector of the u-phase switching element Qu1 is connected to the positive electrode terminal, which is the high-voltage side of the in-vehicle electricity storage device 104 via the filter circuit 31. The emitter of the u-phase switching element Qu2 is connected to the negative electrode terminal, which is the low-voltage side of the in-vehicle electricity storage device 104 via the filter circuit 31.

Except for the connected coil, the other switching elements Qv1, Qv2, Qw1, Qw2 have the same connection structure as the u-phase switching elements Qu1, Qu2. In the following description, the three-phase switching elements Qu1, Qv1, Qw1 are connected to the positive terminal, which is the high-voltage side of the in-vehicle electricity storage device 104, and are referred to as three-phase upper arm switching elements Qu1, Qv1, Qw1. The three-phase switching elements Qu2, Qv2, Qw2, which are connected to the negative terminal, which is the low-voltage side of the in-vehicle electricity storage device 104, are referred to as three-phase lower arm switching elements Qu2, Qv2, Qw2.

The in-vehicle inverter driving device 14 is a controller having electronic components such as a CPU and a memory. The in-vehicle inverter driving device 14 controls the in-vehicle driving device 13, specifically each of the switching elements Qu1 to Qw2. The in-vehicle inverter driving device 14 is electrically connected to the air-conditioning ECU 103. Based on external command values to the electric motor 11 (command values from the air-conditioning ECU 103), the in-vehicle inverter driving device 14 periodically turns the switching elements Qu1 to Qw2 ON and OFF.

The in-vehicle inverter driving device 14 includes a voltage sensor 41 for detecting the input voltage Vin of the inverter circuit 30 and a current sensor 42 for detecting the motor current flowing through the electric motor 11. The input voltage Vin can be regarded as a voltage input to the in-vehicle driving device 13, the voltage of the in-vehicle electricity storage device 104, and the power supply voltage. The in-vehicle inverter driving device 14 includes a three-phase/two-phase converter 43, which converts three-phase currents Iu, Iv, Iw detected by the current sensor 42 into a d-axis current Id and a q-axis current Iq (hereinafter referred to as two-phase currents Id, Iq), which are perpendicular to each other. The in-vehicle inverter driving device 14 can obtain the two-phase currents Id and Iq with the three-phase/two-phase converter 43.

The motor current refers to the three-phase currents Iu, Iv, Iw flowing through the three-phase coils 24u, 24v, 24w or the two-phase current Id, Iq obtained by three-phase/two-phase conversion of the three-phase currents Iu, Iv, Iq. The d-axis current Id can be regarded as a current of the component in the axial direction of the magnetic flux of the rotor 22, that is, an exciting component current, and the q-axis current Iq can be regarded as a torque component current that contributes to the torque of the electric motor 11.

The in-vehicle inverter driving device 14 includes a position/speed estimating section (position estimating section) 44 for estimating the rotational position and rotational speed of the rotor 22 and a command value deriving section 45 for deriving a command value used to control the inverter circuit 30. The position/speed estimating section 44 estimates the rotational position and rotational speed of the rotor 22 based on the command value and the two-phase currents Id, Iq obtained by the three-phase/two-phase converter 43. This will be described below.

Based on an external command value from the air-conditioning ECU 103 and the two-phase currents Id, Iq obtained by the three-phase/two-phase converter 43, the command value deriving section 45 derives two-phase voltage command values Vdr, Vqr and three-phase voltage command values Vur, Vvr, Vwr. The two-phase voltage command values Vdr, Vqr are composed of the d-axis voltage command value Vdr and the q-axis voltage command value Vqr. The d-axis voltage command value Vdr is a target value of the voltage applied to the d-axis of the electric motor 11, and the q-axis voltage command value Vqr is a target value of the voltage applied to the q-axis of the electric motor 11.

The three-phase voltage command values Vur, Vvr, Vwr are composed of the u-phase voltage command value Vur, the v-phase voltage command value Vvr, and the w-phase voltage command value Vwr. The u-phase voltage command value Vur is a target value of the voltage applied to the u-phase coil 24u. The v-phase voltage command value Vvr is a target value of the voltage applied to the v-phase coil 24v. The w-phase voltage command value Vwr is a target value of the voltage applied to the w-phase coil 24w. That is, the command value deriving section 45 derives a target voltage Vt of the three-phase coils 24u, 24v, 24w.

The command value deriving section 45 includes a two-phase voltage command value deriving section 46 and a two-phase/three-phase converter 47. Based on the external command value, the two-phase currents Id, Iq, and the estimated value of the rotational speed from the position/speed estimating section 44, the two-phase voltage command value deriving section 46 calculates the two-phase voltage command values Vdr and Vqr. Specifically, the two-phase voltage command value deriving section 46 includes a first deriving section 46a and a second deriving section 46b. The first deriving section 46a derives the current command values Idr, Iqr based on the external command value and the estimated value of the rotational speed from the position/speed estimating section 44.

The external command value is, for example, a rotational speed command value. For example, the air-conditioning ECU 103 calculates a necessary flow rate of refrigerant from the operational state of the in-vehicle air conditioner 101 and calculates the rotational speed at which the flow rate can be achieved. Then, the air-conditioning ECU 103 outputs the calculated rotational speed as the external command value to the first deriving section 46a. The external command value is not limited to the rotational speed command value, but any specific command content may be employed as long as the manner in which the electric motor 11 is driven can be defined. Also, the agent of outputting the external command value is not limited to the air-conditioning ECU 103, and is arbitrary.

Based on the two current command values Idr, Iqr derived by the first deriving section 46a and the two-phase currents Id, Iq obtained by the three-phase/two-phase converter 43, the second deriving section 46b derives a two-phase voltage command values Vdr, Vqr. The two-phase voltage command values Vdr, Vqr are delivered to the two-phase/three-phase converter 47 and the position/speed estimation section 44. The two-phase/three-phase converter 47 performs two-phase/three-phase conversion, in which the two-phase voltage command values Vdr, Vqr from the two-phase voltage command value deriving section 46 (more specifically, the second deriving section 46b) are converted into the three-phase voltage command values Vur, Vvr, Vwr.

The in-vehicle inverter driving device 14 includes a PWM control section 50, which performs PWM-control of the switching elements Qu1 to Qw2. The PWM control section 50 performs the PWM-control of the switching elements Qu1 to Qw2 based on the input voltage Vin, the three-phase voltage command values Vur, Vvr, Vwr and the rotational position of the rotor 22 estimated by the position/speed estimating unit 44, thereby controlling the motor current (three-phase currents Iu, Iv, Iw) flowing through the electric motor 11. More specifically, the PWM control section 50 generates a PWM signal based on the three phase voltage command values Vur, Vvr, Vwr, the input voltage Vin, the estimated position of the rotor 22 from the position/speed estimating section 44, and a carrier signal (a carrier wave signal). The PWM control section 50 uses the PWM signal to cause the switching elements Qu1 to Qw2 to perform switching operations. As a result, the two-phase currents Id, Iq that are the same as or close to the current command values Idr, Iqr flow through the electric motor 11.

The carrier signal is a signal used for the PWM control of the inverter circuit 30. A carrier frequency fp, which is the frequency of the carrier signal, is higher than the frequency band of the inflow noise. The PWM control section 50 is configured to be capable of changing the carrier frequency fp. In reality, the in-vehicle inverter driving device 14 brings the two-phase currents Id, Iq flowing through the electric motor 11 close to the current command values Idr, Iqr by executing feedback control. Controlling the current command values Idr, Iqr can be regarded as controlling the two-phase currents Id, Iq flowing through the electric motor 11.

In such a configuration, the position/speed estimating section 44 estimates the rotational position and rotational speed of the rotor 22 based on the detection result of the current sensor 42 (specifically, the two-phase currents Id, Iq obtained by the three-phase/two-phase converting section 43) and/or the two-phase voltage command values Vdr, Vqr. More specifically, the position/speed estimating section 44 calculates the induced voltage in the three-phase coils 24u, 24v, 24w based on the two-phase currents Id, Iq, the d-axis voltage command value Vdr, the motor constant, and the like. Then, the position/speed estimating section 44 estimates the rotational position and rotational speed of the rotor 22 based on the induced voltage, the d-axis current Id, and the like. The specific manner in the position/speed estimating section 44 performs estimation is not limited to the above-described manner, but is arbitrary.

The position/speed estimating section 44 periodically obtains the detection result of the current sensor 42 and periodically estimates the rotational position and rotational speed of the rotor 22. As a result, the position/speed estimating section 44 brings the estimated values closer to the actual rotational position and rotational speed in correspondence with changes in the rotational position and rotational speed of the rotor 22. The in-vehicle inverter driving device 14 has a protection function of detecting an overcurrent or an overvoltage based on the detection result of the current sensor 42 and stopping the operation of the electric motor 11 when an overcurrent or an overvoltage is detected.

Next, a detailed configuration of the PWM control section 50 will be described.

The PWM control section 50 employs a bootstrap method to turn ON the upper arm switching elements Qu1, Qv1, Qw1. Specifically, as shown in FIG. 2, the PWM control section 50 includes a bootstrap circuit 51 having a capacitor 51a. The bootstrap circuit 51 generates a voltage higher than the voltage of the in-vehicle electricity storage device 104 (in other words, the power supply voltage) by using the capacitor 51a. The PWM control section 50 is capable of applying the voltage generated by the bootstrap circuit 51 to the gates of the upper arm switching elements Qu1, Qv1, Qw1, thereby turning ON the upper arm switching elements Qu1, Qv1, Qw1.

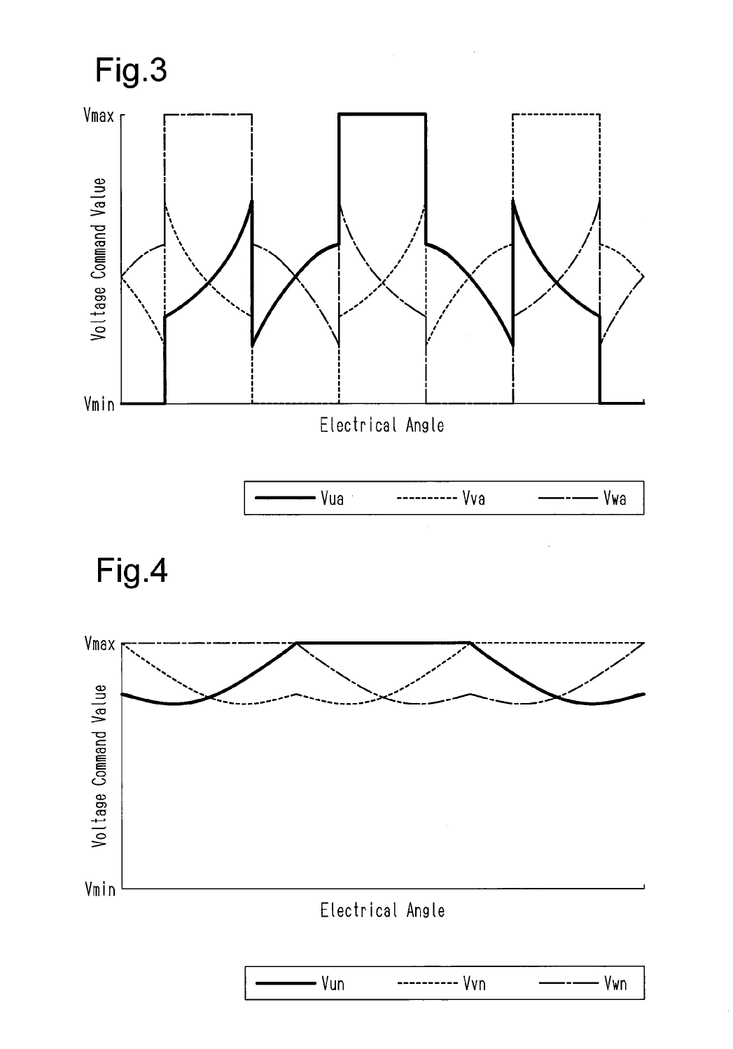

The PWM control section 50 determines the operation mode of each of the switching elements Qu1 to Qw2 based on the three-phase voltage command values Vur, Vvr, Vwr and periodically performs PWM control process to perform PWM control of the switching elements Qu1 to Qw2 in the operation mode. The operation modes include an upper/lower two-phase modulation method and a lower-arm-fixing two-phase modulation method. FIG. 3 is a graph of upper/lower two-phase modulation command values Vua, Vva, Vwa, which are voltage command values corresponding to the upper/lower two-phase modulation method, and FIG. 4 is a graph of lower-arm-fixing two-phase modulation command values Vun, Vvn, Vwn, which are voltage command values corresponding to the lower-arm-fixing two-phase modulation method.

As shown in FIG. 3, the upper/lower two-phase modulation method is a modulation method in which one of the three phases sequentially becomes a fixed phase and the voltage command value of the fixed phase is used as a maximum command value Vmax or a minimum command value Vmin. In the upper/lower two-phase modulation method, the switching operation is performed on each of the two-phase switching elements other than the fixed phase with the dead time Td being set, and one of the upper and lower arm switching elements of the fixed phase is maintained in the ON state and the other is maintained in the OFF state.

For example, when the u-phase is the fixed phase, the switching operation is performed on the v-phase switching elements Qv1, Qv2 and the w-phase switching elements Qw1, Qw2, while no switching operation is performed on the u-phase switching elements Qu1, Qu2. In this case, one of the u-phase switching elements Qu1, Qu2 is maintained in the ON state and the other is maintained in the OFF state.

The maximum command value Vmax corresponds to the negative electrode potential of the in-vehicle electricity storage device 104 and the minimum command value Vmin corresponds to the positive electrode potential of the in-vehicle electricity storage device 104. That is, for example, when the u-phase upper/lower two-phase modulation command value Vua is the maximum command value Vmax, the u-phase voltage Vu, which is applied to the u-phase coil 24u, is 0 (the minimum value). When the u-phase upper/lower two-phase modulation command value Vua is the minimum command value Vmin, the u-phase voltage Vu is the input voltage Vin (the maximum value).

When the maximum command value Vmax is set, the upper arm switching element of the phase for which the maximum command value Vmax is set is in the OFF state and the lower arm switching element in the phase for which the maximum command value Vmax is set is in the ON state. In this case, the duty cycle of the upper arm switching element corresponding to the maximum command value Vmax is 0, and the duty cycle of the lower arm switching element corresponding to the maximum command value Vmax is 1.

When the minimum command value Vmin is set, the upper arm switching element of the phase for which the minimum command value Vmin is set is in the ON state, and the lower arm switching element in the phase for which the minimum command value Vmin is set is in the OFF state. In this case, the duty cycle of the upper arm switching element corresponding to the minimum command value Vmin is 1, and the duty cycle of the lower arm switching element corresponding to the minimum command value Vmin is 0. That is, when the maximum command value Vmax or the minimum command value Vmin is set, no switching operation is performed on the two switching elements of the phases for which the maximum command value Vmax or the minimum command value Vmin is set.

As shown in FIG. 3, in the upper/lower two-phase modulation method, each time the fixed phase is changed, the voltage command value of the fixed phase is alternately changed between the maximum command value Vmax and the minimum command value Vmin. For example, as shown in FIG. 3, if the fixed phase is changed from the u-phase to the v-phase in a situation where the fixed phase is the u-phase and the u-phase upper/lower two phase modulation command value Vua is the maximum command value Vmax, the v-phase upper/lower two-phase modulation command value Vva is set to the minimum command value Vmin. That is, the upper/lower two-phase modulation method is a modulation method in which the voltage command value of the fixed phase is alternately changed between the maximum command value Vmax and the minimum command value Vmin.

As shown in FIG. 4, the lower-arm-fixing two-phase modulation method is a modulation method in which one of the three phases sequentially becomes the fixed phase and the voltage command value of the fixed phase is fixed to the maximum command value Vmax. In the lower-arm-fixing two-phase modulation method, the switching operation is performed on the upper and lower arm switching elements of the two phases other than the fixed phase with the dead time Td being set, and the upper arm switching element of the fixed phase is maintained in the OFF state and the lower arm switching element of the fixed phase is maintained in the ON state.

For example, when the u-phase is the fixed phase, the switching operation is performed on the v-phase switching elements Qv1, Qv2 and the w-phase switching elements Qw1, Qw2, while no switching operation is performed on the u-phase switching elements Qu1, Qu2. In this case, the u-phase upper arm switching element Qu1 is maintained in the OFF state and the u-phase lower arm switching element Qu2 is maintained in the ON state. In the lower-arm-fixing two-phase modulation method, the voltage command value of the fixed phase is never set to the minimum command value Vmin. FIG. 4 is a graph showing the lower-arm-fixing two-phase modulation method in an ideal state in which the dead time Td is not set.

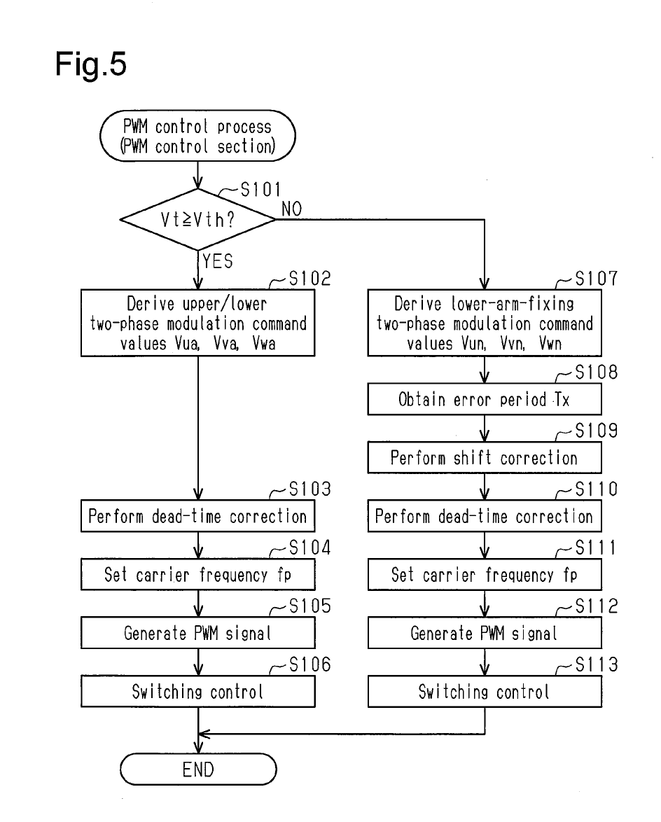

The PWM control process will be described with reference to FIG. 5. The specific hardware configuration of the PWM control section 50, which executes the PWM control process, is arbitrary. For example, the PWM control section 50 may include a memory in which a program of the PWM control process is stored, and a CPU that executes the PWM control process based on the program. In addition, the PWM control section 50 may include one or more hardware circuits that execute each step of the PWM control process.

As shown in FIG. 5, at step S101, the PWM control section 50 first determines whether the target voltage Vt of the three-phase coils 24u, 24v, 24w is higher than or equal to a predetermined threshold voltage Vth. The target voltage Vt is, for example, the magnitude of the two-phase voltage command values Vdr, Vqr (√(Vdr²+Vqr²)). However, the target voltage Vt is not limited to this and is arbitrary as long as it can be derived from the two-phase voltage command values Vdr, Vqr or the three-phase voltage command values Vur, Vvr, Vwr.

The threshold voltage Vth is arbitrary as long as it is a predetermined value. For example, the threshold voltage Vth may be the lower limit value at which the upper/lower two-phase modulation method can be used as the modulation method. More specifically, as described above, the in-vehicle inverter driving device 14 employs a bootstrap method as a method for turning ON the upper arm switching elements Qu1, Qv1, Qw1. In the bootstrap method, a maintainable period in which the upper arm switching elements Qu1, Qv1, Qw1 can be maintained in the ON state depends on the capacitance of the capacitor 51a.

Further, in the upper/lower two-phase modulation method, the PWM control section 50 sets the voltage command value of the fixed phase to the minimum command value Vmin over a required period (more specifically, a period required for the rotor 22 to rotate by an electrical angle of 60°). That is, the PWM control section 50 needs to maintain the upper arm switching element of the fixed phase in the ON state for the required period. The required period varies in accordance with the target voltage Vt. Specifically, the lower the target voltage Vt, the longer the required period tends to be. Therefore, when the target voltage Vt decreases, the required period becomes longer than the maintainable period, and there is a possibility that the upper/lower two-phase modulation method cannot be performed. That is, in the upper/lower two-phase modulation method, there is a usage constraint caused by the capacitor 51a.

In this regard, in the present embodiment, the threshold voltage Vth is set to the target voltage Vt, at which the required period and the maintainable period are the same, and the threshold value Vth is the lower limit value at which the upper/lower two-phase modulation method can be set. In this case, the process of step S101 can be regarded as be a process of determining whether each of the switching elements Qu1 to Qw2 can be operated by the upper/lower two-phase modulation method.

There is a correlation between the target voltage Vt and the rotational speed. Specifically, the lower the rotational speed, the lower the target voltage Vt tends to be. Therefore, the situation where the target voltage Vt is low can be regarded as a situation where the rotational speed is low. In other words, the process of step S101 can be regarded as a process of determining whether the target rotational speed is higher than or equal to a predetermined threshold rotational speed.

The threshold voltage Vth is a parameter that varies in accordance with the input voltage Vin. The PWM control section 50 incudes data in which the input voltage Vin and the threshold voltage Vth are associated with each other. The PWM control section 50 obtains the input voltage Vin from the detection result of the voltage sensor 41 and derives the threshold voltage Vth corresponding to the obtained input voltage Vin by referring to the above data. Then, the PWM control section 50 compares the target voltage Vt with the threshold voltage Vth.

When the target voltage Vt is higher than or equal to the threshold voltage Vth, the PWM control section 50 determines that the upper/lower two-phase modulation method can be used, and operates the switching elements Qu1 to Qw2 by the upper/lower two-phase modulation method. More specifically, at step S102, the PWM control section 50 derives the upper/lower two-phase modulation command values Vua, Vva, Vwa corresponding to the upper/lower two-phase modulation method based on the input voltage Vin, the three-phase voltage command values Vur, Vvr, Vwr, and the rotational position estimated by the position/speed estimating section 44.

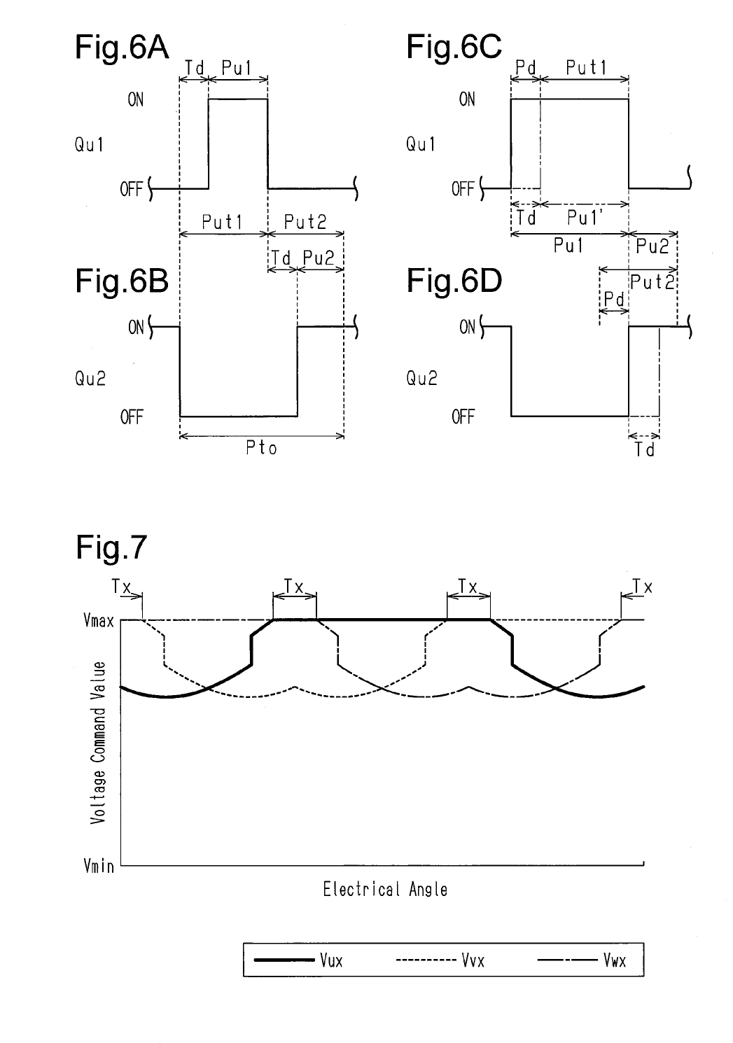

In the following step S103, the PWM control section 50 performs dead-time correction. The dead time Td and the dead-time correction will be described with reference to FIGS. 6A to 6D. FIGS. 6A to 6D show as an example the case where the operated phase is the u-phase.

As shown in FIGS. 6A and 6B, the dead time Td is a period during which both the upper arm switching element and the lower arm switching element in the two phases other than the fixed phase are in the OFF state. The two phases other than the fixed phase are subjected to the switching operation. In the following description, the upper and lower arm switching elements subjected to the switching operation will also be referred to as an operated upper arm switching element and an operated lower arm switching element.

The dead time Td is set at the time of turning ON/OFF of the two operated switching elements. Specifically, the dead time Td is set between the falling edge of the operated lower arm switching element and the rising edge of the operated upper arm switching element and between the falling edge of the operated upper arm switching element and the rising edge of the operated lower arm switching element. The PWM control section 50 adjusts an operated upper arm pulse width, which is the pulse width of the operated upper arm switching element, and an operated lower arm pulse width, which is the pulse width of the operated lower arm switching element, thereby generating the dead time Td.

As an example, a case in which the u-phase is the operated phase will be described. The u-phase upper arm pulse width Pu1, which corresponds to the u-phase upper/lower two-phase modulation command value Vua, is defined as a u-phase upper arm target pulse width Put1. The u-phase lower arm pulse width Pu2, which corresponds to the u-phase upper/lower two-phase modulation command value Vua, is defined as a u-phase lower arm target pulse width Put2. The u-phase lower arm target pulse width Put2 is a value obtained by subtracting the u-phase upper arm target pulse width Put1 from the total pulse width Pto corresponding to one switching cycle. In such a configuration, it is assumed that the u-phase upper arm pulse width Pu1 is set to the u-phase upper arm target pulse width Put1, and the u-phase lower arm pulse width Pu2 is set to the u-phase lower arm target pulse width Put2. In this case, the PWM control sects 50 displaces the u-phase pulse widths Pu1, Pu2 from the u-phase target pulse widths Put1, Put2 so as to generate the dead time Td. For example, as shown in FIGS. 6A and 6B, the PWM control section 50 controls the u-phase switching elements Qu1, Qu2 such that the u-phase pulse widths Pu1, Pu2 become values obtained by subtracting the dead time Td from the u-phase target pulse widths Put1, Put2. The same applies to the v-phase and the w-phase.

The PWM control section 50 performs a process of setting the dead time Td in the process of generating a PWM signal (step S105 and step S112). In other words, the process of step S105 and step S112 can be regarded as a process of setting the dead time Td with respect to the pulse width of the two operated switching elements, and the PWM control section 50, which executes the process of step S105 and step S112, can be regarded as a dead time setting section for setting a dead time.

As described above, when the u-phase pulse widths Pu1, Pu2 deviate from the u-phase target pulse widths Put1, Put2, a deviation due to the dead time Td occurs between the u-phase voltage Vu, which is actually applied to the u-phase coil 24u, and the u-phase upper/lower two-phase modulation command value Vua. Similarly for the v-phase and the w-phase, there is a deviation caused by the dead time Td. Then, a deviation occurs in the voltage control of the electric motor 11, and the controllability of the electric motor 11 deteriorates.

In this regard, in step S103, the PWM control section 50 performs dead-time correction to adjust the pulse widths of the two operated switching elements in correspondence with the dead time Td. For example, as shown in FIGS. 6C and 6D, the PWM control section 50 adds a dead-time correction amount Pd to the u-phase upper arm target pulse width Put1 and sets the u-phase upper arm pulse width Pu1 to the resultant value in advance, such that the u-phase upper arm pulse width Pu1 when the dead time Td is set (indicated by Pu1′ in FIG. 6C) approaches the u-phase upper arm target pulse width Put1.

The dead-time correction amount Pd is set in accordance with the dead time Td. Specifically, under the condition that the dead time Td is set, the dead-time correction amount Pd is set such that the u-phase upper arm pulse width Pu1 subjected to the dead-time correction is brought closer to the u-phase upper arm target pulse width Put1 than the u-phase upper arm pulse width Pu1 not subjected to the dead-time correction. For example, the dead-time correction amount Pd is preferably set to be substantially the same as the dead time Td.

Specifically, in step S103, the PWM control section 50 corrects the u-phase upper/lower two-phase modulation command value Vua, which has been derived at step S102, thereby calculating the u-phase upper/lower two phase modulation correction command value Vub, such that, when the dead time Td is set, the u-phase upper arm pulse width Pu1 (Pu1′ in FIG. 6C) approaches the u-phase upper arm target pulse width Put1.

The u-phase lower arm pulse width Pu2 is set to a value (Pto−Pu1) obtained by subtracting the u-phase upper arm pulse width Pu1 from the total pulse width Pto. If it is assumed that the value obtained by subtracting the u-phase upper arm target pulse width Put1 from the total pulse width Pto is the u-phase lower arm target pulse width Put2, the u-phase lower arm pulse width Pu2 is set to a value (Put2−Pd) obtained by subtracting the dead-time correction amount Pd from the u-phase lower arm target pulse width Put2. The dead-time correction can be regarded as a correction process of adding up the pulse widths of the two operated switching elements or subtracting one of the pulse widths from the other in accordance with the dead time Td.

When the dead time Td is set for the u-phase pulse widths Pu1, Pu2, which are set as described above, the u-phase pulse widths Pu1, Pu2 have waveforms as indicated by the long dashed double-short dashed lines in FIGS. 6C and 6D. The u-phase upper arm pulse width Pu1 for which the dead time Td is set (Pu1′ in FIG. 6C) approaches (preferably coincides with) the u-phase upper arm target pulse width Put1. Similarly, the PWM control section 50 corrects the v-phase upper/lower two-phase modulation command value Vva to calculate a v-phase upper/lower two-phase modulation correction command value Vvb, and corrects the w-phase upper/lower two-phase modulation command value Vwa to calculate a w-phase upper/lower two-phase modulation correction command value Vwb.

The dead-time correction is performed for the operated phase and not for the fixed phase. That is, the dead-time correction is not performed for parts of the upper/lower two-phase modulation command values Vua, Vva, Vwa that are the maximum command value Vmax. Therefore, the parts of the upper/lower two-phase modulation command values Vua, Vva, Vwa that are the maximum command value Vmax are not changed.

As shown in FIG. 5, after executing the process of step S103, the PWM control section 50 proceeds to step S104 and sets the carrier frequency fp corresponding to the upper/lower two-phase modulation method. The carrier frequency fp corresponding to the upper/lower two-phase modulation method is arbitrary as long as it is higher than the resonance frequency f0 (preferably, the cutoff frequency fc) of the filter circuit 31.

In the following step S105, the PWM control section 50 generates a PWM signal, in which switching patterns of the switching elements Qu1 to Qw2 are set, based on the carrier signal and the upper/lower two-phase modulation correction command values Vub, Vvb, Vwb. In this case, the PWM control section 50 shapes the PWM signal such that the dead time Td is set. In the following step S106, the PWM control section 50 performs switching control of the switching elements Qu1 to Qw2 by using the PWM signal and ends the PWM control process.

When the target voltage Vt is lower than the threshold voltage Vth, the PWM control section 50 makes a negative decision at step S101 and operates each of the switching elements Qu1 to Qw2 by the lower-arm-fixing two-phase modulation method. Specifically, at step S107, the PWM control section 50 first derives the lower-arm-fixing two-phase modulation command values Vun, Vvn, Vwn corresponding to the lower-arm-fixing two-phase modulation method based on the input voltage Vin, the three-phase voltage command values Vur, Vvr, Vwr, and the rotational position estimated by the position/speed estimating section 44.

Next, fictitious correction command values Vux, Vvx, Vwx when dead-time correction is performed on the lower-arm-fixing two-phase modulation command values Vun, Vvn, Vwn will be described with reference to FIG. 7.

As shown in FIG. 7, the dead-time correction causes the fictitious correction command values Vux, Vvx, Vwx to deviate from the ideal curves shown in FIG. 4, and an error period Tx occurs in which one of the two operated phases becomes a fixed phase. The error period Tx is a period during which two of the three phases are fixed phases. The error period Tx occurs before and after the fixed phase is changed. The error period Tx is generated intermittently, more specifically, three times periodically in one cycle of the electrical angle.

The error period Tx is a period in which two of the three fictitious correction command values Vux, Vvx, Vwx are set to the maximum command value Vmax. For example, in the error period Tx that occurs when the fixed phase is changed from the w-phase to the u-phase, the u-phase fictitious correction command value Vux and the w-phase fictitious correction command value Vwx are set to the maximum command value Vmax. In this case, the switching operation is performed only for the v-phase, and no switching operation is performed for the u-phase or the w-phase. That is, the duty cycles of the upper arm switching elements Qu1 and Qw1 are 0 while the duty cycles of the two v-phase switching elements Qv1, Qv2 are values other than 0 or 1, and the duty cycles of the lower arm switching elements Qu2, Qw2 are 1.

The error period Tx can cause a voltage error. Therefore, the longer the error period Tx, the greater the voltage error tends to be. The error period Tx tends to become longer as the target voltage Vt (in other words, modulation factor) becomes lower. The error period Tx tends to become longer as the rotational speed of the rotor 22 decreases.

As described above, if the dead-time correction is performed on the lower-arm-fixing two-phase modulation command values Vun, Vvn, Vwn, an error period Tx occurs. As a result, an error occurs between the lower-arm-fixing two-phase modulation command values Vun, Vvn, Vwn and the three-phase voltages Vu, Vv, Vw, which are actually applied to the three-phase coils 24u, 24v, 24w.

To cope with this, the PWM control section 50 of the present embodiment intermittently performs a shifting correction, in which the neutral point voltage of the three-phase coils 24u, 24v, 24w is shifted such that the error period Tx is shortened (preferably, no error period Tx occurs).

Specifically, the PWM control section 50 first obtains the error period Tx at step S108. Specifically, as described above, the PWM control section 50 calculates the fictitious correction command values Vux, Vvx, Vwx in the case where the dead-time correction is performed on the lower-arm-fixing two-phase modulation command values Vun, Vvn, Vwn. Then, the PWM control section 50 obtains the error period Tx based on the fictitious correction command values Vux, Vvx, Vwx. Specifically, the PWM control section 50 obtains the time at which the error period Tx occurs and the duration of the error period Tx in one cycle of the electrical angle. The PWM control section 50 that executes the process of step S108 corresponds to an error period obtaining section.

In the following step S109, the PWM control section 50 performs the shifting correction. The PWM control section 50 performs the shifting correction before the dead-time correction is performed. That is, the PWM control section 50 performs the shifting correction on the lower-arm-fixing two-phase modulation command values Vun, Vvn, Vwn for which the dead-time correction has not been performed.

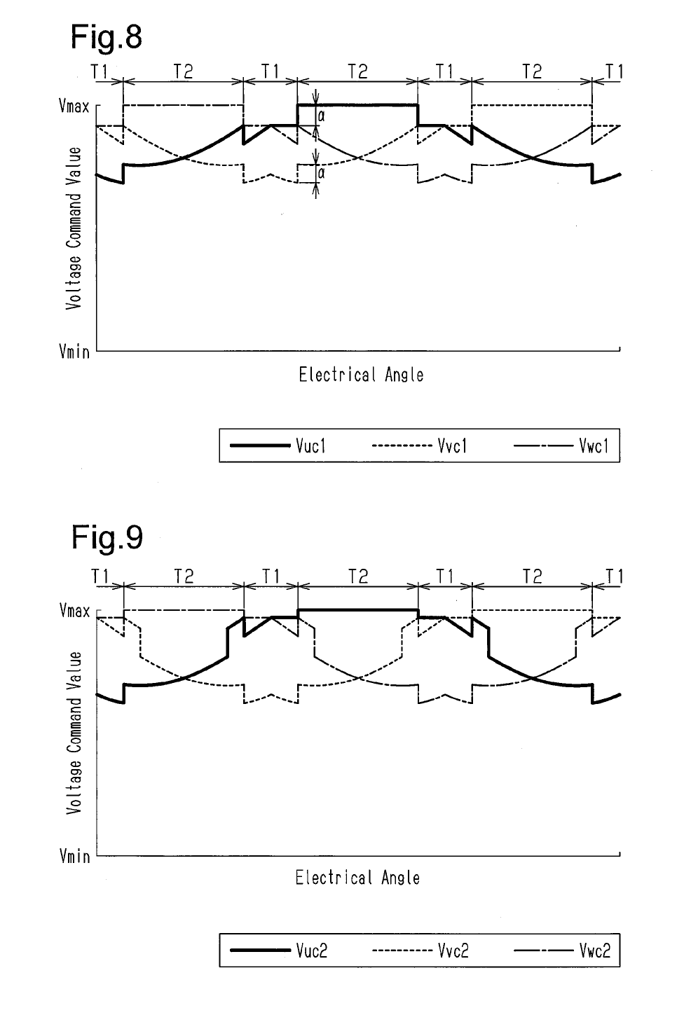

The shifting correction will now be described with reference to FIG. 8. FIG. 8 is a graph of first correction command values Vuc1, Vvc1, Vwc1.

The shifting correction refers to a correction process of reducing the lower-arm-fixing two-phase modulation command values Vun, Vvn, Vwn as a whole (in other words, toward the minimum command value Vmin) while maintaining the relationship between the lower-arm-fixing two-phase modulation command values Vun, Vvn, Vwn. For example, the PWM control section 50 subtracts a predetermined shifting correction amount α from each of the lower-arm-fixing two-phase modulation command values Vun, Vvn, Vwn (Vun−α, Vvn−α, Vwn−α). This shifts the neutral point voltage.

The shifting correction is performed in a period corresponding to the error period Tx. Specifically, the PWM control section 50 sets the timing and period of execution of the shifting correction such that at least part (in the present embodiment, all) of the period corresponding to the error period Tx obtained at step S108 is included in the period of execution of the shifting correction.

As shown in FIG. 7, the error period Tx occurs intermittently (in other words, periodically) with a predetermined period therebetween. Thus, the PWM control section 50 performs the shifting correction intermittently (in other words, periodically) with a predetermined period in between. The lower-arm-fixing two-phase modulation command values Vun, Vvn, Vwn subjected to the shifting correction are defined as first correction command values Vuc1, Vvc1, Vwc1. That is, the process of step S109 is a process of deriving (or in other words, calculating) the first correction command values Vuc1, Vvc1, Vwc1 from the lower-arm-fixing two-phase modulation command values Vun, Vvn, Vwn.

With this configuration, as shown in FIG. 8, in the lower-arm-fixing two-phase modulation system in which the shifting correction is performed intermittently, a shifting correction period T1, in which the shifting correction is performed, and a non-shifting correction period T2, in which the shifting correction is not performed, are set alternately. The first correction command values Vuc1, Vvc1, Vwc1 that correspond to the shifting correction period T1 are lower than the lower-arm-fixing two-phase modulation command values Vun, Vvn, Vwn by the shifting correction amount a. The first correction command values Vuc1, Vvc1, Vwc1 that correspond to the non-shifting correction period T2 are equal to the lower-arm-fixing two-phase modulation command values Vun, Vvn, Vwn. As shown in FIG. 8, at the boundary between the shifting correction period T1 and the non-shifting correction period T2, a step corresponding to the shifting correction amount a is generated.

The shifting correction period T1 completely matches with the error period Tx, but it is not limited to this, and they may be slightly displaced as long as parts thereof overlap with each other. In addition, although the PWM control section 50 is configured to perform the shifting correction for all the three error periods Tx occurring in one cycle of the electrical angle, the present invention is not limited to this. The PWM control section 50 may perform the shifting correction for only one or two of the error periods Tx. In short, it is only necessary that the shifting correction period T1 include at least part of a period corresponding to the error period Tx in one cycle of the electrical angle in the lower-arm-fixing two-phase modulation method. The shifting correction period T1 corresponds to a fixed period.

After executing the shifting correction, the PWM control section 50 performs dead-time correction to adjust the pulse widths of the two operated switching elements in correspondence with the dead time Td at step S110 as shown in FIG. 5. The dead-time correction is as described above. For example, the PWM control section 50 sets the u-phase upper arm target pulse width Put1 to the u-phase upper arm pulse width Pu1 corresponding to the u-phase first correction command value Vuc1. The PWM control section 50 adds or subtracts the dead-time correction amount Pd to or from the u-phase upper arm target pulse width Put1 in advance and sets the u-phase upper arm pulse width Pu1 to the resultant value, such that, when the dead time Td is set, the u-phase upper arm pulse width Pu1 approaches (preferably coincides with) the u-phase upper arm target pulse width Put1.

More specifically, the PWM control section 50 calculates (or derives) a u-phase second correction command value Vuc2 by correcting the u-phase first correction command value Vuc1 such that the u-phase upper arm pulse width Pu1 when the dead time Td is set approaches the u-phase upper arm target pulse width Put1. Likewise, the PWM control section 50 corrects the v-phase first correction command value Vvc1 to calculate a v-phase second correction command value Vvc2 and corrects the w-phase first correction command value Vwc1 to calculate a w-phase second correction command value Vwc2. Each of the second correction command values Vuc2, Vvc2, Vwc2 is a voltage command value that is set such that the dead-time correction amount Pd, which corresponds to the dead time Td, is added to or subtracted from the pulse width of the operated switching element corresponding to each of the first correction command values Vuc1, Vvc1, Vwc1. That is, the process of step S110 is a process of calculating (or deriving) the second correction command values Vuc2, Vvc2, Vwc2 from the first correction command values Vuc1, Vvc1, Vwc1.

The shifting correction amount α is set to be larger than the amount of fluctuation of the voltage command value due to the dead-time correction, more specifically, the difference between the first correction command values Vuc1, Vvc1, Vwc1 and the second correction command values Vuc2, Vvc2, Vwc2. As a result, the second correction command values Vuc2, Vvc2, Vwc2, which correspond to the shifting correction period T1, are lower than the maximum command value Vmax.

The shifting correction amount α is arbitrary as long as any one of the first correction command values Vuc1, Vvc1, Vwc1 is not set to the minimum command value Vmin. For example, the shifting correction amount α is preferably set to a small value within a range in which the correction command value corresponding to the fixed phase is lower than the maximum command value Vmax when the dead-time correction is performed. Further, the shifting correction amount α is preferably smaller than twice the difference between the first correction command values Vuc1, Vvc1, Vwc1 and the second correction command values Vuc2, Vvc2, Vwc2.

As shown in FIG. 5, after executing the dead-time correction, the PWM control section 50 proceeds to step S111 and sets the carrier frequency fp. The PWM control section 50 differentiates the carrier frequency fp between the shifting correction period T1 and the non-shifting correction period T2. For example, the PWM control section 50 sets a first carrier frequency fp1, which is the carrier frequency fp in the shifting correction period T1, to be lower than a second carrier frequency fp2, which is the carrier frequency fp in the non-shifting correction period T2. For example, the first carrier frequency fp1 is half the second carrier frequency fp2.

The first carrier frequency fp1 is set to be lower than the resonance frequency f0 of the filter circuit 31 such that twice the first carrier frequency fp1 is higher than the resonance frequency f0 (preferably, the cutoff frequency fc of the filter circuit 31). In the present embodiment, the carrier frequency fp corresponding to the upper/lower two-phase modulation method and the second carrier frequency fp2 are equal to each other. However, these two frequencies may be different from each other. Also, the first carrier frequency fp1 may be a value different from half the second carrier frequency fp2, and may be higher than or equal to the second carrier frequency fp2, for example.

In the following step S112, the PWM control section 50 generates a PWM signal, in which switching patterns of the switching elements Qu1 to Qw2 are set, based on the carrier signal and the second correction command values Vuc2, Vvc2, Vwc2. In this case, the PWM control section 50 shapes the PWM signal such that the dead time Td is set. In the following step S113, the PWM control section 50 performs switching control of the switching elements Qu1 to Qw2 by using the PWM signal and ends the PWM control process.

The second correction command values Vuc 2, Vvc 2, Vwc 2 will be described with reference to FIG. 9.

As shown in FIG. 9, the second correction command values Vuc2, Vvc2, Vwc2 are lower than the maximum command value Vmax even during the shifting correction period T1. Therefore, in the shifting correction period T1, the switching is performed for all the three phases. In other words, the operated switching elements during the shifting correction period T1 are all the switching elements Qu1 to Qw2. In the non-shifting correction period T2, the dead-time correction is performed for two operation target phases out of the three phases, while the dead-time correction is performed for all the three phases in the shifting correction period T1.

Focusing on the fact that the switching operation is performed for all three phases in the shifting correction period T1, it can be said that substantially the three-phase modulation method is executed during the shifting correction period T1. Thus, it can be said that the lower-arm-fixing two-phase modulation method during the shifting correction period T1 is pseudo. In this case, the lower-arm-fixing two-phase modulation method, in which the shifting correction has been performed, can also be regarded as be a modulation method in which the modulation method is alternately switched between the lower-arm-fixing two-phase modulation method and the three-phase modulation method. In this respect, the PWM control section 50 controls the inverter circuit 30 based on the second correction command values Vuc2, Vvc2, Vwc2, for which the shifting correction and the dead-time correction have been performed on the lower-arm-fixing two-phase modulation command values Vun, Vvn, Vwn of the three phases, thereby performing the three-phase modulation method for a fixed period (the shifting correction period T1).

It can be said that the PWM control section 50 controls the inverter circuit 30 by a specific modulation method in which the modulation method is alternately changed between the lower-arm-fixing two-phase modulation method and the three-phase modulation method, and that the shifting correction period T1 is a period in which the modulation method is the three-phase modulation method and the neutral point voltage is shifted. That is, the first correction command values Vuc1, Vvc1, Vwc1 are three-phase voltage command values that correspond to the three-phase modulation method, in which the neutral point voltage is shifted in the shifting correction period T1 and correspond to the lower-arm-fixing two-phase modulation method in the non-shifting correction period T2.

As a result of the shifting correction, the error period Tx, in which two phases out of the three phases become fixed phases, does not occur in one cycle of the electrical angle as shown in FIG. 9. That is, it can be said that the shifting correction period T1 is set such that no error period Tx occurs when the dead-time correction is performed on the first correction command values Vuc1, Vvc1, Vwc1. The waveforms of the second correction command values Vuc2, Vvc2, Vwc2 in the shifting correction period T1 are closer to the waveforms of the lower-arm-fixing two-phase modulation command values Vun, Vvn, Vwn than the fictitious correction command values Vux, Vvx, Vwx, which have been subjected to the dead-time correction without executing the shifting correction. For this reason, the second correction command values Vuc2, Vvc2, Vwc2 are less likely to cause a voltage error than the fictitious correction command values Vux, Vvx, Vwx.

In the upper/lower two-phase modulation method, since the voltage command value of the fixed phase is alternately changed between the maximum command value Vmax and the minimum command value Vmin, the error period Tx is unlikely to occur. Particularly, the upper/lower two-phase modulation method is executed in a situation where the target voltage Vt is higher than or equal to the threshold voltage Vth, in other words, in a situation where the rotational speed is relatively high. Thus, even if the error period Tx is caused by the dead-time correction, the error period Tx tends to be short. Therefore, a voltage error is unlikely to occur between the upper/lower two-phase modulation command values Vua, Vva, Vwa and the three-phase voltages Vu, Vv, Vw, which are actually applied to the three-phase coils 24u, 24v, 24w.

In the present embodiment, the PWM control section 50 that executes the process of step S101 corresponds to a modulation method selecting section, and the PWM control section 50 that executes the processes of steps S102, S105, and S106 corresponds to an upper/lower two-phase modulation control section. The PWM control section 50 that executes the processes of steps S107, S112, S113 corresponds to a specific modulation control section. Particularly, the PWM control section 50 that executes the process of steps S107 corresponds to a lower-arm-fixing two-phase modulation command value deriving section. The PWM control section 50 that executes the processes of steps S108 and S109 corresponds to a shifting correction section. The PWM control section 50 that executes the process of step S110 corresponds to a dead-time correction section. The PWM control section 50 that executes the process of step S111 corresponds to a carrier frequency setting section.

The present embodiment, which has been described above, achieves the following operational advantages.

(1) The in-vehicle inverter driving device 14 is used for the PWM control of the inverter circuit 30 that drives the electric motor 11. The electric motor 11 has the rotor 22, which includes the permanent magnet 22a and the stator 23. The three-phase coils 24u, 24v, 24w are wound about the stator 23. The inverter circuit 30 includes the three-phase upper arm switching elements Qu1, Qv1, Qw1 and the three-phase lower arm switching elements Qu2, Qv2, Qw2. The three-phase upper arm switching elements Qu1, Qv1, Qw1 are connected to the high-voltage side of the in-vehicle electricity storage device 104, which serves as a direct current power supply. The three-phase lower arm switching elements Qu2, Qv2, Qw2 are connected to the low-voltage side of the in-vehicle electricity storage device 104. The in-vehicle inverter driving device 14 includes the bootstrap circuit 51, which turns ON the upper arm switching elements Qu1, Qv1, Qw1 by using the capacitor 51a.

The PWM control section 50 of the in-vehicle inverter driving device 14 performs a process (step S107) of deriving the lower-arm-fixing two-phase modulation command values Vun, Vvn, Vwn of the three phases, which are three-phase voltage command values corresponding to the lower-arm-fixing two-phase modulation method. The PWM control section 50 performs the dead-time correction to adjust the pulse widths of the lower-arm-fixing two-phase modulation command values Vun, Vvn, Vwn of the three phases in accordance with the dead time Td. The PWM control section 50 also performs the shifting correction to correct the lower-arm-fixing two-phase modulation command values Vun, Vvn, Vwn of the three phases such that the three-phase modulation method is executed during the shifting correction period T1, which is the fixed period. Then, the PWM control section 50 controls the inverter circuit 30 (specifically, each of the switching elements Qu1 to Qw 2) based on the second correction command values Vuc2, Vvc2, Vwc2 of the three phases that have been subjected to the above two correction operations.

With this configuration, the specific modulation method can be employed in which the three-phase modulation method is executed over the shifting correction period T1 and the lower-arm-fixing two-phase modulation method is executed over the other period (non-shifting correction period T2). In the specific modulation method, the switching loss is smaller than when the modulation method is always the three-phase modulation method, and it is not necessary to maintain the upper arm switching elements Qu1, Qv1, Qw1 in the ON state for a long period. Thus, in a situation where it is difficult to use the upper/lower two-phase modulation method due to the usage constraint caused by the bootstrap circuit 51 (specifically, the capacitor 51a), for example, in a situation where the target voltage Vt is relatively low, the specific modulation method can be executed to reduce the switching loss.

Further, in the present embodiment, the dead-time correction is performed on the lower-arm-fixing two-phase modulation command values Vun, Vvn, Vwn, and the three-phase modulation method is executed over the shifting correction period T1, which is the fixed period. Thus, the voltage error can be reduced as compared with the case where the dead-time correction is performed in the lower-arm-fixing two-phase modulation method. Specifically, if the dead-time correction is simply performed on the lower-arm-fixing two-phase modulation command values Vun, Vvn, Vwn, the error period Tx, which can cause a voltage error, is generated. To cope with this, the error period Tx can be shortened (preferably, eliminated) by performing the three-phase modulation method during the period that corresponds to the error period Tx. As a result, it is possible to restrain deterioration of the controllability of the electric motor 11 due to the voltage error while reducing the switching loss.

(2) The PWM control section 50 intermittently performs the shifting correction. Specifically, in response to the occurrence of the error period Tx before and after the change of the fixed phase, the PWM control section 50 periodically performs the shifting correction over periods before and after the change of the fixed phase. Thus, in the lower-arm-fixing two-phase modulation method in which the shifting correction has been performed (that is, the specific modulation method), the shifting correction period T1, in which the shifting correction is performed, and the non-shifting correction period T2, in which the shifting correction is not performed, appear alternately. The non-shifting correction period T2 is a period in which the modulation method is the lower-arm-fixing two-phase modulation method. The shifting correction period T1 is a period in which the neutral point voltage is shifted with respect to the non-shifting correction period T2 and the modulation method is the three-phase modulation method.

In the shifting correction, in which the neutral point voltage is shifted, the three phases are subjected to the switching operation. That is, there is no fixed phase in the shifting correction period T1. Therefore, the switching loss tends to be large in the shifting correction period T1.

In this respect, in the present embodiment, the PWM control section 50 sets a first carrier frequency fp1, which is the carrier frequency fp in the shifting correction period T1, to be lower than a second carrier frequency fp2, which is the carrier frequency fp in the non-shifting correction period T2. This restrains increase in switching loss caused by performing the shifting correction.

The shift correction is performed intermittently, and the switching operation is not always performed for the three phases. Thus, in the lower-arm-fixing two-phase modulation method (that is, the specific modulation method), in which the shifting correction is performed, the switching loss tends to be lower than in the three-phase modulation method, in which the switching operation is always performed for the three phases.

(3) The first carrier frequency fp1 is set to be lower than the resonance frequency f0 of the filter circuit 31, which is provided on the input side of the inverter circuit 30 and reduces the inflow noise contained in the DC current delivered from the in-vehicle electricity storage device 104. Twice the first carrier frequency fp1 is set to be higher than the resonance frequency f0 (preferably, than the cutoff frequency fc). With this configuration, by making the first carrier frequency fp1 lower than the resonance frequency f0, the switching loss can be further reduced as compared with the configuration in which the first carrier frequency fp1 is higher than or equal to the resonance frequency f0.

Since the switching operation is performed by the three-phase modulation method in the shifting correction period T1, the frequency of the fundamental wave of the ripple noise generated in the inverter circuit 30 during the shifting correction period T1 is twice the first carrier frequency fp1. Therefore, when twice the first carrier frequency fp1 is higher than the resonance frequency f0, the ripple noise is reduced by the filter circuit 31. Thus, it is possible to restrain the ripple noise generated in the inverter circuit 30 from flowing out of the in-vehicle driving device 13 during the shifting correction period T1, while reducing the switching loss in the shifting correction period T1.

(4) The frequency of the fundamental wave of the ripple noise generated in the inverter circuit 30 during the non-shifting correction period T2 is equal to the second carrier frequency fp2. In this respect, the second carrier frequency fp2 of the present embodiment is set to be higher than the resonance frequency f0 (preferably, than the cutoff frequency fc). This restrains the ripple noise generated in the inverter circuit 30 during the non-shifting correction period T2 from flowing out of the in-vehicle driving device 13.

(5) The first carrier frequency fp1 is half the second carrier frequency fp2. With this configuration, the frequencies of the ripple noise are the same in the shifting correction period T1 and the non-shifting correction period T2. It is thus possible to avoid a situation in which only one of the ripple noise corresponding to the shifting correction period T1 and the ripple noise corresponding to the non-shifting correction period T2 is reduced by the filter circuit 31.

(6) The PWM control section 50 performs the shifting correction to subtract the predetermined shifting correction amount α from each of the lower-arm-fixing two-phase modulation command values Vun, Vvn, Vwn (Vun−α, Vvn−α, Vwn−α, Vvn−α, Vvn−α) over the shifting correction period T1, thereby deriving the first correction command values Vuc1, Vvc1, Vwc1 (step S109). The first correction command values Vuc1, Vvc1, Vwc1 are three-phase voltage command values that are set such that the neutral point voltage is shifted in the shifting correction period T1 and the modulation method is the lower-arm-fixing two-phase modulation method in the non-shifting correction period T2.

Further, the PWM control section 50 performs the dead-time correction for the three-phase first correction command values Vuc1, Vvc1, Vwc1 such that the dead-time correction amount Pd corresponding to the dead time Td is added to or subtracted from the pulse widths of the two switching elements subjected to the switching operation, thereby deriving the three-phase second correction command values Vuc2, Vvc2, Vwc2. Then, the PWM control section 50 controls each of the switching elements Qu1 to Qw2 based on the respective second correction command values Vuc2, Vvc2, Vwc2, thereby controlling the inverter circuit 30 by the specific modulation method, in which the modulation method is alternately switched between the lower-arm-fixing two-phase modulation method and the three-phase modulation method. The shifting correction period T1 is set such that no error period Tx occurs or the error period Tx is shortened when the dead-time correction is performed on the three-phase first correction command values Vuc1, Vvc1, Vwc1. The same advantage as the above item (1) is thus achieved.

If the dead-time correction is performed before the shifting correction is performed, the error period Tx occurs. Even if the shifting correction is performed on the waveform of the voltage command value in which the error period Tx has occurred, the deviation between the voltage command value subjected to the shifting correction and the lower-arm-fixing two-phase modulation command values Vun, Vvn, Vwn is large, and the voltage error is cannot be easily reduced.

To cope with this, the PWM control section 50 of the present embodiment executes the dead-time correction after executing the shifting correction as described above. As a result, the second correction command values Vuc2, Vvc2, Vwc2 are brought closer to the lower-arm-fixing two-phase modulation command values Vun, Vvn, Vwn. This reduces the voltage error in a favorable manner.

(7) The shift correction amount α is larger than the difference between the first correction command values Vuc1, Vvc1, Vwc1 and the second correction command values Vuc2, Vvc2, Vwc2. With this configuration, even if any of the lower-arm-fixing two-phase modulation command values Vun, Vvn, Vwn is the maximum command value Vmax, each of the second correction command values Vuc2, Vvc2, Vwc2 in the shifting correction period T1 is lower than the maximum command value Vmax. Accordingly, in the shifting correction period T1, the switching operation is performed for all the three phases. Therefore, the occurrence of the error period Tx is avoided.

(8) The shifting correction amount α is set to a small value within a range in which the correction command value corresponding to the fixed phase is lower than the maximum command value Vmax when the dead-time correction is performed. For example, the shifting correction amount α is set to be smaller than twice the difference between the first correction command values Vuc1, Vvc1, Vwc1 and the second correction command values Vuc2, Vvc2, Vwc2. This configuration reduces the fluctuation range of the voltage command value corresponding to the fixed phase at the boundary between the shifting correction period T1 and the non-shifting correction period T2. This improves the continuity of the voltage command value corresponding to the fixed phase, so that the distortion of the waveform is suppressed.

(9) The PWM control section 50 is configured to execute the process (steps S102, S105, S106) of controlling the inverter circuit 30 in the upper/lower two-phase modulation method and the process of selecting the modulation method of the inverter circuit 30 between the lower-arm-fixing two-phase modulation method, in which the shifting correction is performed (that is, the specific modulation method), and the upper/lower two-phase modulation method. With this configuration, the electric motor 11 is driven in a more favorable manner by selecting the modulation method.

Specifically, in the upper/lower two-phase modulation method, the influence of the voltage error due to the dead-time correction is small as described above. Thus, it is not necessary to perform the shifting correction in the upper/lower two-phase modulation method. Therefore, the switching loss tends to be smaller in the upper/lower two-phase modulation method than in the specific modulation method. However, in the upper/lower two-phase modulation method, there is a usage constraint caused by the bootstrap circuit 51. In contrast, there is no usage constraint caused by the bootstrap circuit 51 in the specific modulation method.

In this regard, in this embodiment, for example, when the upper/lower two-phase modulation method can be used, the upper/lower two-phase modulation method is selected. When the upper/lower two-phase modulation scheme cannot be used, the specific modulation method can be selected. Accordingly, the switching loss can be reduced.

(10) When the target voltage Vt of the three-phase coils 24u, 24v, 24w is higher than or equal to the predetermined threshold voltage Vth, the PWM control section 50 selects the upper/lower two-phase modulation method. When the target voltage Vt is lower than the threshold voltage Vth, the PWM control section 50 selects the specific modulation method. With this configuration, the target voltage Vt is employed as the selection criterion of the modulation method. The target voltage Vt is a parameter related to a required period during which each of the upper arm switching elements Qu1, Qv1, Qw1 must be maintained in the ON state. Specifically, the higher the target voltage Vt, the shorter the required period tends to be. In this regard, in the present embodiment, when the target voltage Vt is higher than or equal to the threshold voltage Vth, the upper/lower two-phase modulation method is selected. When the target voltage Vt is lower than the threshold voltage Vth, the specific modulation method is selected. This allows the optimum modulation method to be selected.

In a situation where the target voltage Vt is relatively low such that the target voltage Vt is lower than the threshold voltage Vth, the error period Tx tends to be long. For this reason, the influence of the error period Tx cannot be ignored. To cope with this, in the present embodiment, the error period Tx can be shortened or eliminated by performing the shifting correction by the PWM control section 50 as described above. As a result, even when the specific modulation method is selected under the condition that the target voltage Vt is lower than the threshold voltage Vth, it is possible to suppress the deterioration of the controllability of the electric motor 11.

(11) The in-vehicle motor-driven compressor 10 includes the compression portion 12, the electric motor 11, the in-vehicle driving device 13, and the in-vehicle inverter driving device 14. The compression portion 12 compresses refrigerant, which is fluid. The in-vehicle driving device 13 has the inverter circuit 30. With this configuration, the in-vehicle inverter driving device 14 executes the above-described process, thereby improving the efficiency of the in-vehicle motor-driven compressor 10 through the reduction of the switching loss, and suppressing deterioration of the controllability of the in-vehicle motor-driven compressor 10 by suppressing deterioration of the controllability of the electric motor 11.

Particularly, when the voltage error as described above occurs, the controllability of the currents flowing through the three-phase coils 24u, 24v, 24w deteriorates. Specifically, a deviation occurs between the two-phase currents Id, Iq and the two-phase current command values Idr, Iqr. This can cause an overvoltage or an overcurrent. In this case, the operation of the electric motor 11 is stopped by the protection function. This may cause a disadvantage that the operation of the in-vehicle motor-driven compressor 10 is stopped. In this regard, since the present embodiment suppresses the voltage error, the above disadvantage is avoided.

(12) The in-vehicle inverter driving device 14 includes the position/speed estimating unit 44, which estimates the rotational position and rotational speed of the rotor 22 based on the three-phase currents Iu, Iv, Iw flowing through the three-phase coils 24u, 24v, 24w and the two-phase voltage command values Vdr, Vqr. This allows the rotational position and rotational speed of the rotor 22 to be obtained without providing a dedicated sensor.

In this configuration, when a voltage error is generated between the actual three-phase voltages Vu, Vv, Vw and the lower-arm-fixing two-phase modulation command values Vun, Vvn, Vwn or the upper/lower two-phase modulation command values Vua, Vva, Vwa corresponding to the two-phase voltage command values Vdr, Vqr, a deviation occurs between the estimation result of the position/speed estimating section 44 and the actual rotational position and rotational speed of the rotor 22. In this regard, the present embodiment suppresses the voltage error, thereby improving the estimation accuracy of the position/speed estimating section 44.

The above described embodiment may be modified as follows.

The determination criterion for selecting the modulation method is not limited to the target voltage Vt, but may be, for example, the rotational speed. Further, for example, the PWM control section 50 may select the modulation method based on the operational state of the in-vehicle motor-driven compressor 10. The operational state may be, for example, at the time of startup, steady operation, acceleration, deceleration, or the like.

The modulation method is not limited to two: the lower-arm-fixing two-phase modulation scheme (the specific modulation method), in which the shifting correction is performed, and the upper/lower two-phase modulation method. For example, other modulation methods (for example, a three-phase modulation method) may be employed depending on the situation.

The shift correction amount α may be smaller than the difference between the first correction command values Vuc1, Vvc1, Vwc1 and the second correction command values Vuc2, Vvc2, Vwc2. Even in this case, since the error period Tx is shortened, the voltage error is suppressed.

Instead of the position/speed estimating section 44, the in-vehicle inverter driving device 14 may include a dedicated sensor (for example, a resolver).

In the above-described embodiment, the in-vehicle inverter driving device 14 derives the lower-arm-fixing two-phase modulation command values Vun, Vvn, Vwn or the upper/lower two-phase modulation command values Vua, Vva, Vwa from the three phase voltage command values Vur, Vvr, Vwr. However, the present invention is not limited thereto, the in-vehicle inverter driving device 14 may derive the lower-arm-fixing two-phase modulation command values Vun, Vvn, Vwn or the upper/lower two-phase modulation command values Vua, Vva, Vwa directly from, for example, the two-phase voltage command values Vdr and Vqr. That is, it is not indispensable to derive the three-phase voltage command values Vur, Vvr, Vwr.

The order of the PWM control processes is arbitrary. For example, the PWM control section 50 may derive the modulation command values after setting the carrier frequency fp.

The filter circuit 31 may be omitted.

The in-vehicle motor-driven compressor 10 does not necessary need to be employed for the in-vehicle air conditioner 101, but may be employed for other devices. For example, if the vehicle 100 is a fuel cell vehicle, the motor-driven compressor 10 may be used in an air supplying device that supplies air to the fuel cell. That is, the fluid to be compressed is not limited to refrigerant, but may be any fluid such as air.

The in-vehicle fluid machine is not limited to the in-vehicle motor-driven compressor 10 provided with the compression portion 12 for compressing fluid. For example, in the case in which the vehicle 100 is a fuel cell vehicle, the in-vehicle fluid machine may be an electric pump device having a pump that supplies hydrogen to the fuel cell without compressing it and an electric motor that drives the pump. In this case, the in-vehicle driving device 13 to be controlled by the in-vehicle inverter driving device 14 may be used for the electric motor for driving the pump.

1. An in-vehicle inverter driving device that is used to perform PWM control of an inverter circuit that drives an electric motor, wherein the electric motor includes a rotor having a permanent magnet and a stator about which three-phase coils are wound, wherein
the inverter circuit includes
three-phase upper arm switching elements, which are connected to a high-voltage side of a DC power supply, and
three-phase lower arm switching elements, which are connected to a low-voltage side of the DC power supply,
the in-vehicle inverter driving device comprising:
a bootstrap circuit, which includes a capacitor and uses the capacitor to turn ON the three-phase upper arm switching elements; and
a lower-arm-fixing two-phase modulation command value deriving section, which derives lower-arm-fixing two-phase modulation command values of three phases, the lower-arm-fixing two-phase modulation command values being voltage command values corresponding to a lower-arm-fixing two-phase modulation method, wherein
in the lower-arm-fixing two-phase modulation method,
one of the three phases sequentially becomes a fixed phase,
in a state in which a dead time is set, a switching operation is performed on the upper and lower arm switching elements of the two phases other than the fixed phase,
the upper arm switching element of the fixed phase is maintained in an OFF state, and
the lower arm switching element of the fixed phase is maintained in an ON state, and
the in-vehicle inverter driving device further comprises a specific modulation control section, which performs a dead-time correction to adjust pulse widths of the lower-arm-fixing two-phase modulation command values of the three phases in accordance with the dead time and corrects the lower-arm-fixing two-phase modulation command values of the three phases such that a three-phase modulation method is executed during a fixed period.

2. The in-vehicle inverter driving device according to claim 1, wherein
the specific modulation control section includes
a shifting correction section, which performs a shifting correction to subtract a predetermined shifting correction amount from each of the lower-arm-fixing two-phase modulation command values of the three phases over the fixed period, thereby deriving three-phase first correction command values that are set such that, in the fixed period, the modulation method is the three-phase modulation method and a neutral point voltage is shifted, and
a dead-time correction section, which performs the dead-time correction for the three-phase first correction command values such that a dead-time correction amount corresponding to the dead time is added to or subtracted from the pulse widths of the two switching elements subjected to the switching operation, thereby deriving three-phase second correction command values,
the specific modulation control section controls the three-phase upper arm switching elements and the three phase lower arm switching elements based on the three phase second correction command values, thereby controlling the inverter circuit by a specific modulation method, in which the modulation method is alternately changed between the lower-arm-fixing two-phase modulation method and the three-phase modulation method, and
the fixed period, in which the shifting correction is performed, is set such that, when the dead-time correction is performed for the three-phase first correction command values, an error period, in which two of the three phases become fixed phases, is shortened or not generated.

3. The in-vehicle inverter driving device according to claim 2, further comprising a carrier frequency setting section, which sets a carrier frequency of a carrier signal used in the PWM control of the inverter circuit,
wherein the carrier frequency setting section sets a first carrier frequency, which is the carrier frequency in the fixed period in which the shifting correction is performed, to be lower than a second carrier frequency, which is the carrier frequency in a non-shifting correction period in which the shifting correction is not performed.

4. The in-vehicle inverter driving device according to claim 3, wherein
the first carrier frequency is set to be lower than a resonance frequency of a filter circuit, which is provided on an input side of the inverter circuit and reduces inflow noise contained in DC current delivered from the DC power supply, and
twice the first carrier frequency is higher than the resonance frequency.

5. The in-vehicle inverter driving device according to claim 3, wherein the first carrier frequency is half the second carrier frequency.

6. The in-vehicle inverter driving device according to claim 2, wherein the shifting correction amount is greater than a difference between the first correction command value and the second correction command value.

7. The in-vehicle inverter driving device according to claim 2, further comprising an upper/lower two-phase modulation control section, which controls the inverter circuit by an upper/lower two-phase modulation method, wherein
in the upper/lower two-phase modulation method,
one of the three phases sequentially becomes a fixed phase,
in a state in which a dead time is set, a switching operation is performed on the upper and lower arm switching elements of the two phases other than the fixed phase,
one of the upper arm switching element and the lower arm switching element of the fixed phase is maintained in an ON state, and
the other is maintained in an OFF state, and the in-vehicle inverter driving device further comprises a modulation method selecting section, which selects the modulation method of the inverter circuit between the specific modulation method and the upper/lower two-phase modulation method.

8. The in-vehicle inverter driving device according to claim 7, wherein
the modulation method selecting section selects, as the modulation method, the upper/lower two-phase modulation method when a target voltage of the three-phase coils is higher than or equal to a predetermined threshold voltage, and
the modulation method selecting section selects, as the modulation method, the specific modulation method when the target voltage is lower than the threshold voltage.

9. The in-vehicle inverter driving device according to claim 2, wherein
the specific modulation control section includes an error period obtaining section, which obtains the error period by deriving three-phase fictitious correction command values in a case in which the dead-time correction is performed for the lower-arm-fixing two-phase modulation command values of the three phases,
the fixed period in which the shifting correction is performed includes at least part of a period that corresponds to the error period in the lower-arm-fixing two-phase modulation command values of the three phases, and
the shifting correction is configured such that the error period is shortened or not generated when the dead-time correction is performed for the three-phase first correction command values.

10. An in-vehicle inverter driving device that is used to perform PWM control of an inverter circuit that drives an electric motor, wherein the electric motor includes a rotor having a permanent magnet and a stator about which three-phase coils are wound, wherein
the inverter circuit includes
three-phase upper arm switching elements, which are connected to a high-voltage side of a DC power supply, and
three-phase lower arm switching elements, which are connected to a low-voltage side of the DC power supply,
the in-vehicle inverter driving device comprises:
a bootstrap circuit, which includes a capacitor and uses the capacitor to turn ON the three-phase upper arm switching elements; and
a command value deriving section, which drives lower-arm-fixing two-phase modulation command values of three phases, the lower-arm-fixing two-phase modulation command values being three-phase voltage command values corresponding to a lower-arm-fixing two-phase modulation method, wherein
in the lower-arm-fixing two-phase modulation method,
one of the three phases sequentially becomes a fixed phase,
in a state in which a dead time is set, a switching operation is performed on the upper and lower arm switching elements of the two phases other than the fixed phase,
the upper arm switching element of the fixed phase is maintained in an OFF state, and
the lower arm switching element of the fixed phase is maintained in an ON state,
the in-vehicle inverter driving device further comprises:
a shifting correction section, which performs a shifting correction to subtract a predetermined shifting correction amount from each of the lower-arm-fixing two-phase modulation command values of the three phases over a shifting correction period, thereby deriving three-phase first correction command values that are set such that, in the shifting correction period, the modulation method is the three-phase modulation method and a neutral point voltage is shifted, and
a specific modulation control section, which includes a dead-time correction section, wherein the dead-time correction section performs a dead-time correction for the three-phase first correction command values, thereby deriving three-phase second correction command values, and wherein the specific modulation control section controls the inverter circuit based on the second correction command values,
the dead-time correction is a correction in which pulse widths of the two switching elements subjected to the switching operation are adjusted in accordance with the dead time, and
the shifting correction period is set in accordance with the error period such that, when the dead-time correction is performed for the three-phase first correction command values, an error period, in which two of the three phases become fixed phases, is shortened or not generated.

11. An in-vehicle fluid machine comprising:
an electric motor, which includes a rotor having a permanent magnet and a stator about which three-phase coils are wound;
an inverter circuit, which drives the electric motor; and
the in-vehicle inverter driving device according to claim 1.
